(19) United States
(12) Patent Application Publication
(10) Pub. No.: US 2004/0153404 A1
(43) Pub. Date: Aug. 5, 2004

(54) Convergent invoicing system and method

(76) Inventors: Joern Rischmueller, Schwetzingen (DE); Harald Hinderer, Heidelberg (DE)

Correspondence Address: KENYON & KENYON, 1500 K STREET, N.W., SUITE 700, WASHINGTON, DC, 20005, US

(21) Appl. No.: 10/356,072

(22) Filed: Jan. 31, 2003

(51) Int. Cl. G06F 17/60

(52) U.S. Cl. 705/40; 705/34

(57) ABSTRACT

A convergent invoicing system and method for accepting multiple billing information streams or pre-billing information streams from different sources and converging the information streams so that a single invoice can be generated for a specific customer. Multiple invoices could instead be generated if the customer so desires. The invoice can be output to any of a number of different output devices.

### FIELD OF THE INVENTION

This invention relates to a convergent invoicing system and method for converging billing information from a plurality of distinct billing information sources into a single invoice for a customer. The present invention is particularly useful in industries such as the telecommunications service industry where a customer may be receiving products and services for which separate billing streams may be generated.

### BACKGROUND OF THE INVENTION

Certain businesses, such as telecommunications service providers, may offer several different services to customers that generate different billing information streams. In the telecommunications service industry, many mergers have occurred across different market segments, such as local service, long distance service, wireless service (including cellular and digital), high-speed Internet service (including DSL service and cable modem service), pay television service (such as cable TV), hardware sales and others. Many companies have also branched out into new segments. Many of these services offered by telecommunications service providers historically have had separate and distinct billing systems used to keep track of the usage of a customer, rate or pricing information and/or to generate an invoice for billing for such services.

Referring now to FIG. 1, an accounting network according to the prior art is shown. This figure depicts a network that may well be in use by various telecommunications service providers offering services and products across market segments.

Several different billing systems interface to receivables management functionality 100 through streams of billing information. The type of billing streams and the billing systems mentioned hereinafter are given solely as examples and are not intended to be taken as an exhaustive list of such streams and systems. Wireless billing system 110 communicates with receivables management functionality 100 through wireless billing stream 114. Wireless billing system 110 may include a mediation function 111, a rating function 112 and a billing function 113. As used herein, a mediation function receives network events and prepares them for rating and a rating function assigns a price to a network event. A pre-paid billing system 120 communicates with receivables management functionality 100 through pre-paid stream 124. Alternatively, a separate pre-paid stream 125 may interface with another billing system 130. Pre-paid billing system 120 may include a mediation function 121, a rating function 122 and a debiting function 123.

Billing system 130 may be an Internet service billing system, for instance. Internet service billing system 130 may have a mediation function 131, a rating function 132 and a billing function 133. This billing system 130 also communicates with receivable management functionality 100 through Internet billing stream 134.

A third party billing system 140 may also be involved. For instance, many customers have a different long distance carrier than their local service provider, but are billed by their local service provider for both their local service and long distance service. Third party billing system 140 may have a rating and pricing function 141 and interface to one of the other billing systems, such as Internet service billing system 130 through third party billing stream 145. Another billing system 150 is shown for handling billing for hardware. This hardware billing system 150 may include a product/pricing function 151 and a billing function 152. Hardware billing system may communicate with receivables management functionality through hardware billing stream 154. Other types of billing systems that could be used include long distance service, maintenance, repairs, custom care, etc.

Receivables management functionality 100 interfaces with general ledger accounting functionality 101. It also interacts with web-enabled self-service functionality 160 for permitting customers to access their invoices through the receivables management functionality 100.

With this broadening of services offered through both mergers and branching out into new market segments, service providers may be forced to either use separate invoices for the same customer generated by its existing billing systems or to replace its current billing systems with a new integrated system. Sending out separate bills can be a customer relations problem as most customers would rather pay just one bill as opposed to multiple bills. Additionally, it increases costs in mailing, handling, and maintaining additional invoices.

However, replacing the various billing systems with an integrated system tends to be an expensive alternative and may not be worth the cost to a business. Another potential problem with replacing existing billing systems with an integrated billing system is that if new services are added, the new system may not be able to handle them. Thus, either another billing system would need to be added to handle billing for the new service, resulting again in the multiple invoicing problem, or the integrated billing system would need to be replaced with a newer integrated billing system.

Thus, a need exists for an inexpensive manner of converging billing information into a single invoice without necessitating the replacement of existing billing systems and that can easily adapt as new services are added that have different billing information.

### SUMMARY OF THE INVENTION

The present invention relates to convergent invoicing functionality that can be either added to existing accounting networks or included in new billing systems. This functionality accepts multiple billing information streams or pre-billing information streams from different sources and permits the converging of the information so that a single invoice (or more if it is desirable) can be generated for a specific customer.

The present invention has many advantages over the prior art. It provides increased flexibility enabling invoice creation across several billing streams. It also permits one to control the number of invoices sent to a customer each month. The present invention permits cross-product discounting based on total invoice, for example. This can be done because all of the billing information is available in one invoice. The present invention also permits flexible formatting and distribution of invoices.

The present invention reduces costs by reducing the number of invoices generated, maintained and mailed and by providing a better view of customers. It also protects capital investments by permitting service providers to keep their existing billing systems or replace them as desired. Furthermore, it enhances time to market for new services because it permits new billing streams for new technologies and services to be quickly added.

An embodiment of the present invention provides a system and method for converging a plurality of billing information streams into a desired number of invoices, such as a single invoice.

Another embodiment of the present invention provides a system and method for converging a plurality of billing information streams into a single invoice and outputting that invoice to at least one of a variety of outputs.

Another embodiment of the present invention provides an accounting network for converging a plurality of billing information streams into a desired number of invoices.

As such, it is an object of the present invention to provide for the converging of billing information streams from multiple sources and the generation of a desired number of invoices therefrom and to output the invoices to selected outputs.

### BRIEF DESCRIPTION OF THE DRAWINGS

FIG. 1 is a block diagram depicting a network of billing systems according to the prior art.

FIG. 2 is a block diagram depicting a network of billing systems including convergent invoicing functionality according to an embodiment of the present invention.

FIG. 3 is a block diagram of a process flow for convergent invoicing according to an embodiment of the present invention.

### DESCRIPTION OF THE PREFERRED EMBODIMENTS

The present invention will be better understood by reference to the accompanying drawings.

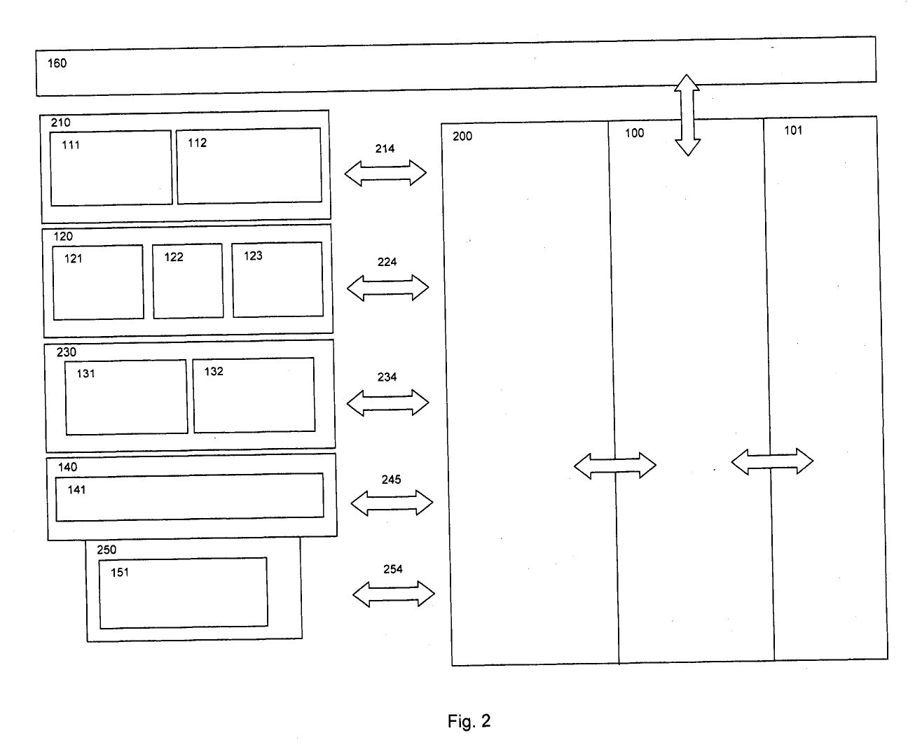

Referring now to FIG. 2, an accounting network is shown having convergent invoicing functionality according to an embodiment of the present invention. Receivables management functionality 100 here again communicates with general ledger accounting functionality 101, web-enabled self-service functionality 160. However, it now no longer directly communicates with billing systems 110, 120, 130, 140 and 150, but instead communicates with convergent invoicing functionality 200.

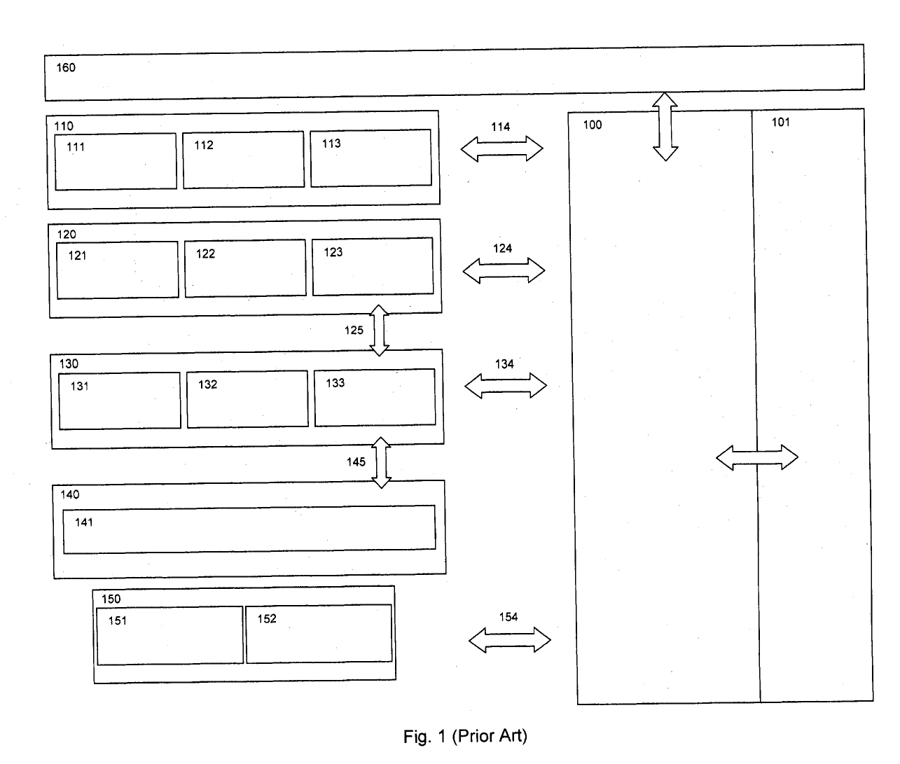

Convergent invoicing functionality 200 receives information from a variety of sources. These sources may be the same billing systems described with respect to FIG. 1 or pre-billing systems as described hereinafter or any combination thereof. By accepting any of these systems, the present invention permits telecommunications service providers, for example, to keep legacy billing systems intact, add new billing or pre-billing systems as needed and/or replace legacy systems with pre-billing systems. Wireless pre-billing system 210 is similar to wireless billing system 110 of FIG. 1, but does not need billing function 113. Information relating to usage and rates may be passed along from wireless pre-billing system 210 to convergent invoicing functionality 200 through wireless information stream 214.

Pre-paid billing system 120 may be connected to convergent invoicing functionality 200 through pre-paid billing stream 224 conveying information relating to usage, rates and debits. Internet pre-billing system 230 may be connected to convergent invoicing functionality 200 through Internet information stream 234. Internet pre-billing system 230 is similar to Internet billing system 130 of FIG. 1, but does not need the billing function 133.

Third party billing system 140 communicates directly with the convergent billing functionality 200 through third party stream 245, without having to communicate with another billing system as in the system of FIG. 1.

Hardware pre-billing system 250 communicates with convergent invoicing system 200 through hardware information stream 254. Hardware pre-billing system 250 is similar to hardware billing system of FIG. 1, but does not need billing functionality 152.

As can be seen, by adding convergent invoicing functionality, the communication between systems is simplified. Additional billing or pre-billing systems can easily be added as the telecommunications service providers acquire other companies having legacy systems or branch out into new market segments.

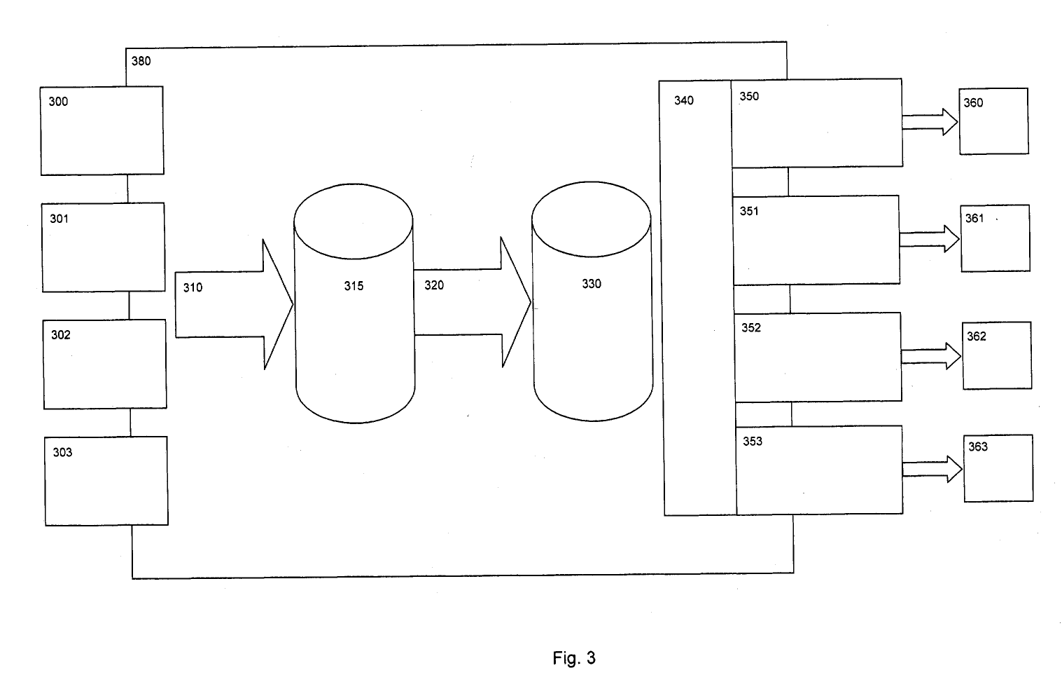

FIG. 3 is a block diagram depicting the convergent invoicing process flow 380 according to an embodiment of the present invention. Various input sources 300, 301, 302 and 303 provide information regarding rates and usage to convergent invoicing functionality 200 to be processed. These input sources may be billing systems and/or pre-billing sources mentioned in the discussion of FIGS. 1 and 2.

The information from input sources 300, 301, 302 and 303 is then input processed 310. Alternatively, the information from the input sources 300, 301, 302 and 303 can be passed on without processing each input stream individually (e.g. pricing). The processed information is then placed in a billing due list 315. Billing/invoicing operations 320 are then performed on information within the billing due list to create invoice documents that are stored in a database 330. One such operation that may be performed is the application of a stored discount scheme. Discount schemes can be applied across input sources based on totals from more than one source. One example of a discount scheme that may be applied is a five percent discount to wireline and wireless calls if the total of wireline and wireless changes exceeds $100.

When the stored invoice documents are to be accessed by a customer or output to a customer and/or a third party, output processing 340 is performed and a processed invoice is sent through the appropriate output 350, 351, 352 or 353. These outputs could be connected to a printer 360, so that an invoice can be printed and mailed; a communications media 361, such as an email or facsimile, so that the bill can be sent directly to the customer for example; another invoicing or billing system 362; or to a formatting system 363 for special formatting of the bill, for example.

Although the preferred embodiments of the present invention have been described and illustrated in detail, it will be evident to those skilled in the art that various modifications and changes may be made thereto without departing from the spirit and scope of the invention as set forth in the appended claims and equivalents thereof.

What is claimed is:

1. A method of automatically converging information relating to billing from a plurality of data sources so that an invoice can be prepared from information from at least two of said data sources, said method being designed to be run on a computerized platform and comprising the steps of:
accepting said information from a plurality of data sources;
creating a billing due list using said information;
creating an invoice for a customer based upon said billing due list;
outputting said invoice.

2. The method of automatically converging billing information as in claim 1, further comprising the step of input processing said information prior to said creating a billing due list step.

3. The method of automatically converging billing information as in claim 1, further comprising the step of storing said invoice prior to outputting said invoice.

4. The method of automatically converging billing information as in claim 1, wherein said creating an invoice step comprises:
creating an invoice document;
storing said invoice document;
output processing said invoice document;
outputting said output processed invoice document.

5. The method of automatically converging invoice information as in claim 4, further comprising the step of applying a stored discount formula to said invoice information.

6. The method of automatically converging billing information as in claim 1, wherein said invoice information comprises data relating to usage by customers and rates for said customers.

7. The method of automatically converging billing information as in claim 1, wherein said invoice information comprises billing information for customers.

8. The method of automatically converging invoice information as in claim 1, wherein said sources comprise at least one billing system.

9. The method of automatically converging billing information as in claim 1, wherein said sources comprise at least one pre-billing system.

10. The method of automatically converging billing information as in claim 1, wherein said outputting step comprises outputting said output processed invoice document to a destination based upon a stored predetermined preference.

11. The method of automatically converging billing information as in claim 1, wherein said outputting step comprises outputting said output processed invoice document to a destination based upon a command from a customer.

12. The method of automatically converging billing information as in claim 1, wherein said destination comprises at least one of a printer, a communications medium, an invoicing system, a billing system, and a formatting system.

13. A convergent invoicing system comprising:
a plurality of inputs, said plurality of inputs each being designed to accept information relating to at least usage and rates;
a billing due list generator, said billing due list generator generating a billing due list based upon said information;
an invoice generator, said invoice generator generating an invoice based upon said billing due list; and
an output, said output outputting said invoice.

14. The convergent invoicing system as in claim 13, further comprising:
storage media, said storage media storing said billing due list;
a database, said database storing said invoice; and
an output processor, said output processor processing said invoice prior to said invoice being output.

15. A convergent invoicing system as in claim 13, wherein information accepted by each of said plurality of inputs is not individually processed prior to said invoice generator generating said invoice.

16. A convergent invoicing network as in claim 13, further comprising an input processor, said input processor processing said information from said plurality of inputs.

17. A convergent invoicing network as in claim 13, further comprising a discounter, said discounter being capable of storing at least one discount formula and utilizing said at least one discount formula to create a discounted invoice.

18. A convergent invoicing network comprising:
a plurality of sources, each of said sources outputting information relating to at least usage and rates for a customer;
a convergent invoice generator, said convergent invoice generator comprising
a plurality of inputs, said plurality of inputs being designed to accept said information from said plurality of sources;
a billing due list generator, said billing due list generator generating a billing due list based upon said information;
an invoice generator, said invoice generator generating an invoice based upon said billing due list; and
an output, said output outputting said invoice.

19. A convergent invoicing network as in claim 18, further comprising:
a receivables manager, said receivables manager managing accounts receivable;
a general ledger function, said general ledger function providing general ledger accounting functionality; and
a web-enabled self server, said web-enabled self server permitting a customer to access said single invoice over an Internet.

20. A convergent invoicing network as in claim 18, further comprising a plurality of output sources, said output sources comprising at least two of a printer, communications media, an invoicing system, a billing system and a formatting system.

21. A convergent invoicing network as in claim 18, wherein said information from each of said plurality of sources is not individually processed prior to said invoice generator generating said invoice.

22. A convergent invoicing network as in claim 18, wherein said convergent invoice generator further comprises an input processor, said input processor processing said information accepted by said plurality of inputs.

23. A convergent invoicing network as in claim 18, wherein said convergent invoice generator further comprises a discounter, said discounter being capable of storing at least one discount formula and utilizing said at least one discount formula to create a discounted invoice.
